(19) United States
(12) Patent Application Publication
(10) Pub. No.: US 2019/0088121 A1
(43) Pub. Date: Mar. 21, 2019

(54) SYSTEM AND METHOD FOR NOTIFYING VEHICLES OF EXCESSIVE SPEED

(71) Applicant: EVOLUTIONARY MARKINGS, INC., Boise, ID (US)

(72) Inventors: THOMAS R. LINVILLE, BOISE, ID (US); DOUGLAS L. BAKER, BOISE, ID (US)

(21) Appl. No.: 16/137,383

(22) Filed: Sep. 20, 2018

Related U.S. Application Data
(60) Provisional application No. 62/561,088, filed on Sep. 20, 2017.
(60) Provisional application No. 62/661,149, filed on Apr. 23, 2018.

(51) Int. Cl. G08G 1/095; G08G 1/052; G08G 1/01; G08G 1/02

(52) U.S. Cl. CPC G08G 1/095; G08G 1/02; G08G 1/0116; G08G 1/052

(57) ABSTRACT

A traffic management system and method in which detects the speed of a vehicle approaching an intersection or curve in the roadway and alerts the vehicle via road modules and/or one or more light strips embedded in and/or affixed to the surface of the road to illuminate and/or flash to notify the vehicle that is travelling at excessive speed that can be configured to operate in conjunction with roadway signage. The system can be configured to notify a computer onboard the vehicle traveling at an excessive speed that the vehicle is traveling at an excessive speed. The computer can be located on board an autonomous vehicle.

### TECHNICAL FIELD

The presently disclosed technology generally relates to the field of road safety, and more particular embodiments relate to systems or methods of managing traffic.

### SUMMARY OF THE DISCLOSURE

The purpose of the summary is to enable the public, and especially the scientists, engineers, and practitioners in the art who are not familiar with patent or legal terms or phraseology, to determine quickly from a cursory inspection, the nature and essence of the technical disclosure of the application. The summary is neither intended to define the inventive concept(s) of the application, which is measured by the claims, nor is it intended to be limiting as to the scope of the inventive concept(s) in any way.

What is disclosed is a method of providing enhanced traffic signaling in response to road surface conditions and/or traffic conditions. The method includes the step of providing a plurality of road modules and/or one or more light strips. In a preferred embodiment the plurality of road modules and/or one or more light strips have one or more Light Emitting Diode (LED) lights and/or another light source. The road modules and/or one or more light strips include a light configured for illumination and de-illumination. The road modules and/or one or more light strips are embedded in and/or affixed to the surface of a road proximate to a road corner, road intersection and/or other locations where notification of excessive speed is warranted such as school, construction and municipality speed zones. The road modules and/or one or more light strips can be embedded in or affixed to a road surface, either within, proximate, or transverse to lines or striping that delineate traffic lanes or otherwise. The road modules and/or light strips can be embedded in or affixed to the road surface spanning a partial lane of travel, a complete lane of travel, or across the entire roadway. The light strips can be continuous and/or two or more light strips can be positioned adjacent to one another in a lane to provide the appearance of a continuous light strip. The road modules and/or one or more light strips include a receiver configured for communicating with a processor. The receiver can be a transceiver. The road modules and/or one or more light strips are configured to illuminate, change color, and/or flash in response to a communication from said processor.

The method includes the step of providing at least one sensor configured for detection of the speed of a vehicle traveling on the surface of said road. The sensor can be separate from or integral with the processor of the system.

The method includes the step of providing at least one processor configured for wireless and/or wired communication with the sensor. The processor is further configured for wireless and/or wired communication with the plurality of road modules and/or one or more light strips. The processor is configured to communicate to said road modules and/or one or more light strips to illuminate, change color, and/or flash upon signal from the processor. The processor is configured to communicate this signal to the road modules and/or one or more light strips when a vehicle is traveling on the surface of the road at a speed in excess of a predetermined maximum allowable speed for the conditions of the road.

The maximum allowable speed can be a speed determined for the road in ideal environmental conditions (dry roadway in the daylight). The maximum allowable speed can vary depending on the weather, road, and/or traffic conditions. For example, the processor can be provided with a variety of pre programmed maximum allowable speeds dependent on weather conditions. If a sensor in communication with the processor determines that the road is wet or icy, the processor can be programmed to select a maximum allowable speed correct for the conditions. Alternatively the processor can be configured to receive a weather forecast and/or traffic alert from external applications, such as via Wi-Fi or cellular data source.

The method includes the step of sensing via the sensor the speed of a vehicle traveling on the road in which the road modules and/or one or more light strips are located. This speed is relayed or communicated to the processor for determining if the vehicle is exceeding the maximum allowable speed for the road in general or for the specific conditions that exist at that time. The processor and sensor can be configured for wired and/or wireless communication.

The method includes the step of the processor comparing the speed of the vehicle traveling on said road with the maximum allowable speed for a vehicle on the road. If that speed is too high, the method then moves to the step of the processor sending a signal to the road modules and/or one or more light strips to illuminate and/or flash. This step serves to notify the driver of the vehicle, including a computer driving an autonomous vehicle, that the vehicle is traveling in excess of said maximum allowable speed.

The road modules and/or one or more light strips can include a solar module and/or a vibration energy harvesting device and an energy storage device to provide power to the road modules and/or one or more light strips. Alternatively the road modules and/or one or more light strips can be wired for power from an external source. The road modules and/or one or more light strips can include at one or more antennae configured for receiving wireless communication from the processor. In a preferred embodiment a solar generator is positioned proximate to the roadway to provide power to the road modules and/or light strips. In a further preferred embodiment the solar collector is connected to an energy storage device, such as a battery, that stores energy for future use by the system.

The processor can be configured to communicate with a computer located onboard a vehicle. This includes communicating wirelessly to a computer located in a vehicle that the vehicle is traveling at a speed in excess of a maximum allowable speed. The computer located onboard a vehicle can be in an autonomous vehicle.

The method further can include the step of operation in conjunction with a road sign located proximate to said road corner and/or intersection. The road sign is configured for displaying a message to oncoming traffic on the road. The said road sign is configured to be in communication with the processor. The road sign is configured to display a message alerting said vehicle that said vehicle is traveling too fast when it receives a communication from said processor.

The method further can include the step of the processor communicating to the road module to de-illuminate, stop changing color, and/or stop flashing when a vehicle is no longer travelling at an excessive speed proximate to the road corner and/or road intersection. After a vehicle has slowed down or left the corner, the processor signals the road modules and/or one or more light strips to stop signaling traffic.

What is further disclosed is a method of providing enhanced traffic signaling in response to a vehicle approaching an intersection. A plurality of road modules and/or one or more light strips are provided embedded in or affixed to the surface of a roadway. The road modules and/or one or more light strips have at least one light configured for illumination and de-illumination. The road modules and/or one or more light strips have a receiver configured for communicating with a processor. The road modules and/or one or more light strips are configured to illuminate, change color, and/or flash in response to a communication from the processor.

At least one sensor is provided that is configured for detection of a vehicle approaching an intersection of two or more roadways, in this case called a first roadway and a second roadway. The intersection can have one or more stop signs or road light signals to signal directives to approaching vehicles.

At least one processor is provided that is configured for communication with the sensor and configured for communication with the plurality of road modules and/or one or more light strips. The processor is configured to communicate to the road modules and/or one or more light strips to illuminate, change color, and/or flash when a vehicle is traveling on a first roadway toward the intersection. The road modules and/or light strips are embedded in or on at least the second roadway to provide the vehicle traveling on the second roadway notice that a vehicle is approaching the intersection on the first roadway. Similar sensors and road modules and/or sensors can be used in each of the roadways approaching the intersection to provide notice to vehicles approaching the intersection on alternative roadways notice of vehicles approaching on the other roadways.

The method includes the step of sensing via the sensor an event of a vehicle traveling on said first roadway toward said intersection and communicating the event to said processor. The processor the sends a signal to the road modules and/or one or more light strips in or on said second roadway to illuminate and/or flash.

The road modules and/or light strip(s) can be used in conjunction with one or more signs configured to display a message and/or illuminate upon approach by a vehicle. For example, the sign can be configured to display a verbal warning to roadway travelers in said first roadway when a vehicle is traveling on the second roadway and approaching the intersection. The processor in this example is configured to communicate to said sign to display said verbal warning and/or illuminate and/or flash when said sensor detects a vehicle traveling on said second roadway and approaching said intersection.

### BRIEF DESCRIPTION OF THE DRAWINGS

FIG. 1 illustrates a curve in a roadway at which an embodiment of the presently disclosed invention is installed.

FIG. 2 illustrates a curve in a roadway at which an embodiment of the presently disclosed invention is installed utilizing road modules without light strips.

FIG. 3 illustrates an intersection between two roadways at which an embodiment of the presently disclosed invention is installed.

FIG. 4 illustrates the intersection between two roadways at which an embodiment of the presently disclosed invention is installed of FIG. 3 but with road modules and without light strips.

FIG. 5 illustrates a flow diagram of a preferred embodiment of the invention in which a sensor for sensing the speed of a vehicle is located within a road module.

FIG. 6 illustrates a flow diagram of a preferred embodiment of the invention in which a sensor for sensing the speed of a vehicle is located independent of a road module.

FIG. 7 illustrates the intersection between two roadways at which an embodiment of the presently disclosed invention is installed in conjunction with signs that act in conjunction with road modules and/or light strips to alert oncoming vehicles of the presence of other vehicles approaching the intersection.

FIG. 8 illustrates the intersection of FIG. 7 but with both road modules and light strips installed in each roadway to provide notification to oncoming vehicles.

### DETAILED DESCRIPTION OF THE PREFERRED EMBODIMENTS

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined herein.

In the following description and in the figures, like elements are identified with like reference numerals. The use of “e.g.,” “etc,” and “or” indicates non-exclusive alternatives without limitation unless otherwise noted. The use of “including” means “including, but not limited to,” unless otherwise noted.

Disclosed herein is a system and method of managing traffic with the use of pavement marker modules and/or one or more light strips. What is disclosed is a method of providing enhanced traffic signaling in response to a vehicle traveling at an excessive speed on a road approaching a corner and/or intersection or occurrence, such as a road construction zone, school zone and/or a city, municipality or other area with a slower speed zone. When such an occurrence is detected, the system and/or method then causes road modules and/or one or more light strips embedded in and/or affixed to the surface of the road to illuminate and/or flash to notify the vehicle that is travelling at excessive speed to slow down. This can include, for example, a white, colored, or multi light colored road module changing color or flashing a different color than in a normal operating mode.

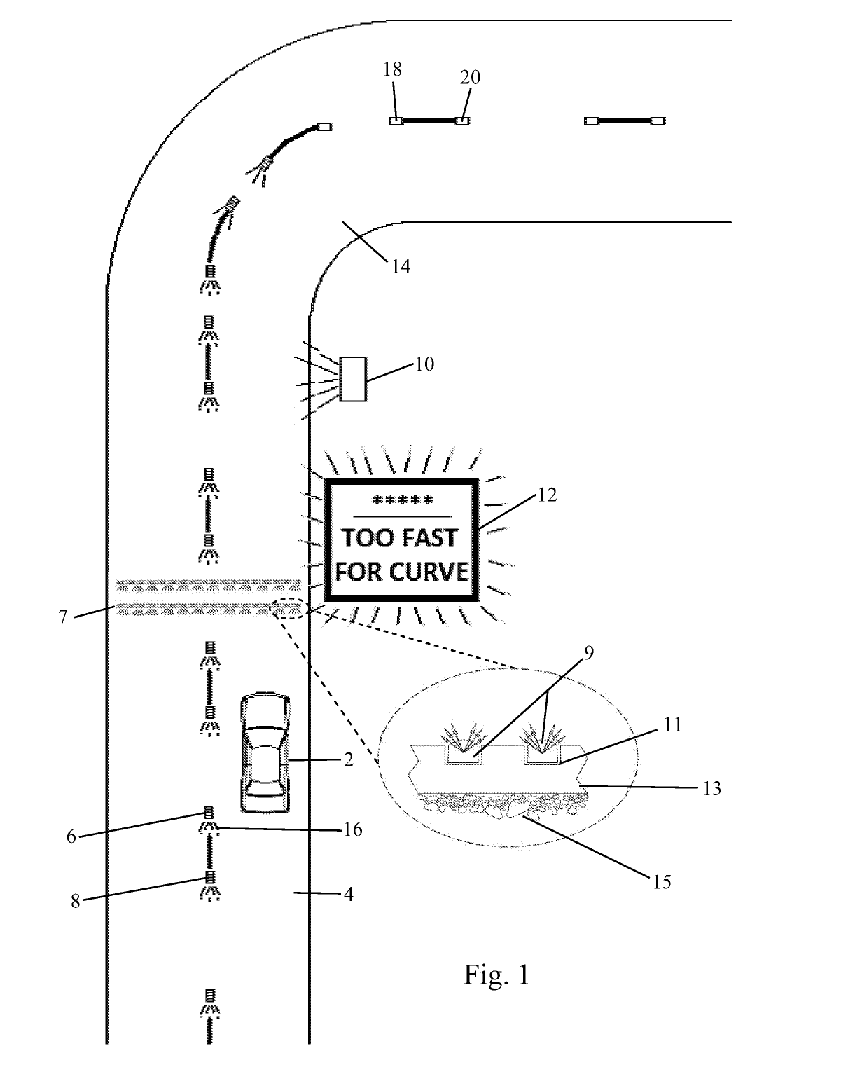

FIG. 1 depicts a vehicle 2 traveling on a roadway 4. The roadway has road modules 6, 8, 18, 20 and/or one or more light strips 7, 9 embedded in or affixed to the surface of the road. As the vehicle approaches a corner 14 in the road a sensor 10 detects the speed of the vehicle traveling in the road. A processor utilizes the sensed speed and compares the sensed speed to the maximum speed for travel on the roadway. If the vehicle's speed exceeds the maximum speed for the roadway at the corner, the processor sends a signal to the road modules and/or one or more light strips leading up to the curve and optionally road modules and/or one or more light strips 18, 20 in the surface of the road following the curve. The signal directs the road modules and/or one or more light strips to illuminate and/or flash 16 thus warning the vehicle that its speed is too high for the corner. Optionally a sign 12, as is already known in the art, can display notification to the vehicle that it is traveling too fast for the corner in conjunction with the use of the roadway markers embedded in or affixed to the surface of the road. The road markers can be embedded in or affixed to the roadway in a variety of locations, included but not limited to in the center line of the road, in the edge lines of a road, in the stop line of a road, or in one or more lanes of the road. Alternatively to or in addition to the road modules, one or more light strips 7 can be utilized to provide traffic signaling in a roadway surface 11. In a preferred embodiment the light strips are embedded 9 in the surface of a roadway 11, as depicted in the cutaway illustrating the relationship of an example light strip in regard to the surface of the roadway and road bed 15.

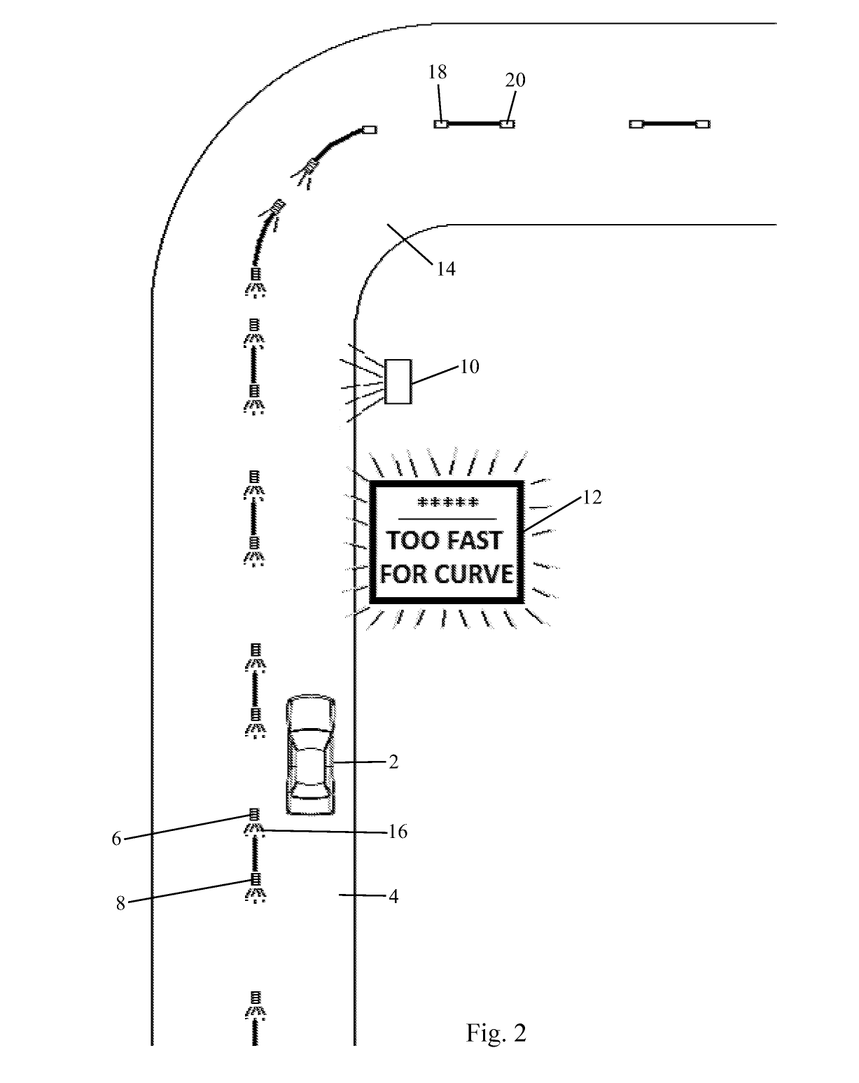

For example, the maximum speed for a roadway or section of a roadway such as a corner can be a pre-determined speed or alternatively the maximum speed can be determined by the processor depending on the conditions of the corner. For example, if it is raining and the corner is wet the processor can be configured to accept this factor in calculating the maximum pre-determined speed. Optionally the processor can be configured to send a notification to a computer located onboard the vehicle notifying the vehicle that the vehicle is traveling at too fast of a speed and/or notifying the computer on board the vehicle to slow the vehicle's speed. This includes notifying a computer of an autonomous vehicle. FIG. 2 illustrates the system of FIG. 1 but with road modules installed. The system can be installed using road modules, light strips, or both as illustrated in FIG. 1.

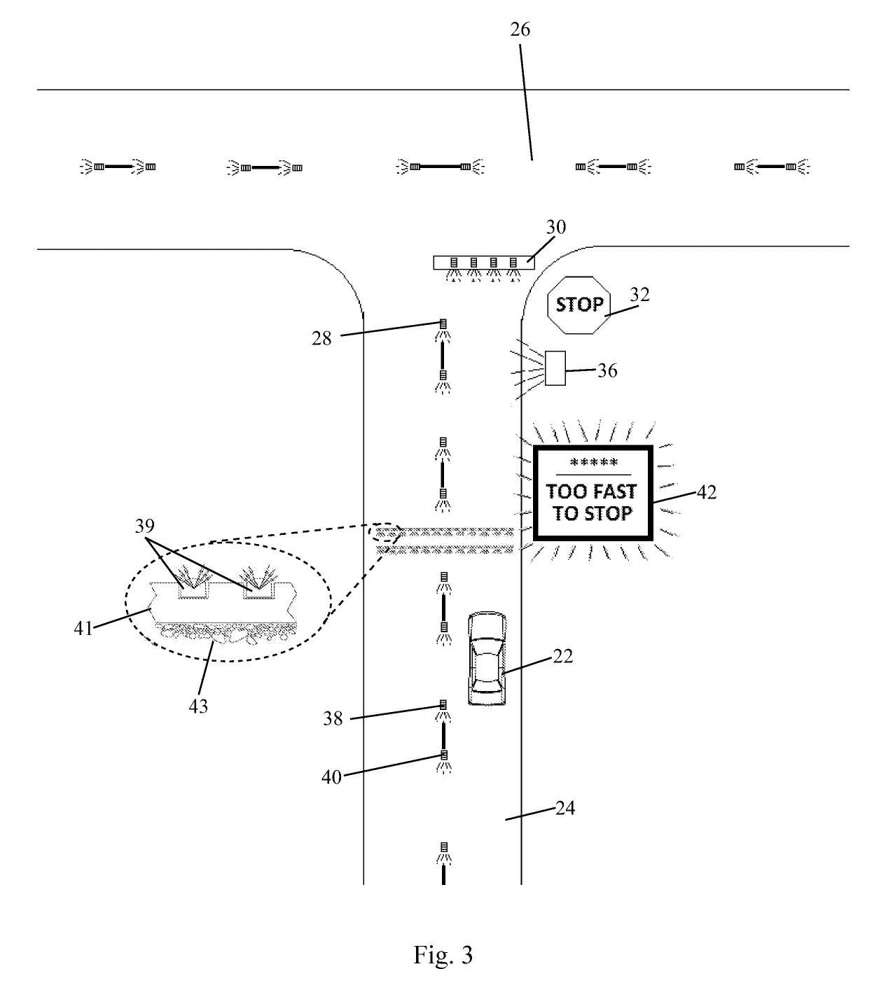

FIG. 3 depicts the system of FIG. 1 utilized at the approach of an intersection 26. The depicted intersection is a T intersection utilizing a stop sign 32 and/or traffic lights or road modules and/or one or more light strips embedded in and/or affixed to the surface of the road. As a vehicle 22 traveling on a road 24 approaches the intersection a sensor 36 senses the speed of the vehicle. The sensor 36 can be located either external to the road modules and/or one or more light strips or integrated into the road modules and/or one or more light strips. A processor located either external to the road modules and/or one or more light strips or integrated into the road modules and/or one or more light strips or integral with the sensor determines if the speed sensed is in excess of the maximum allowable speed for the road.

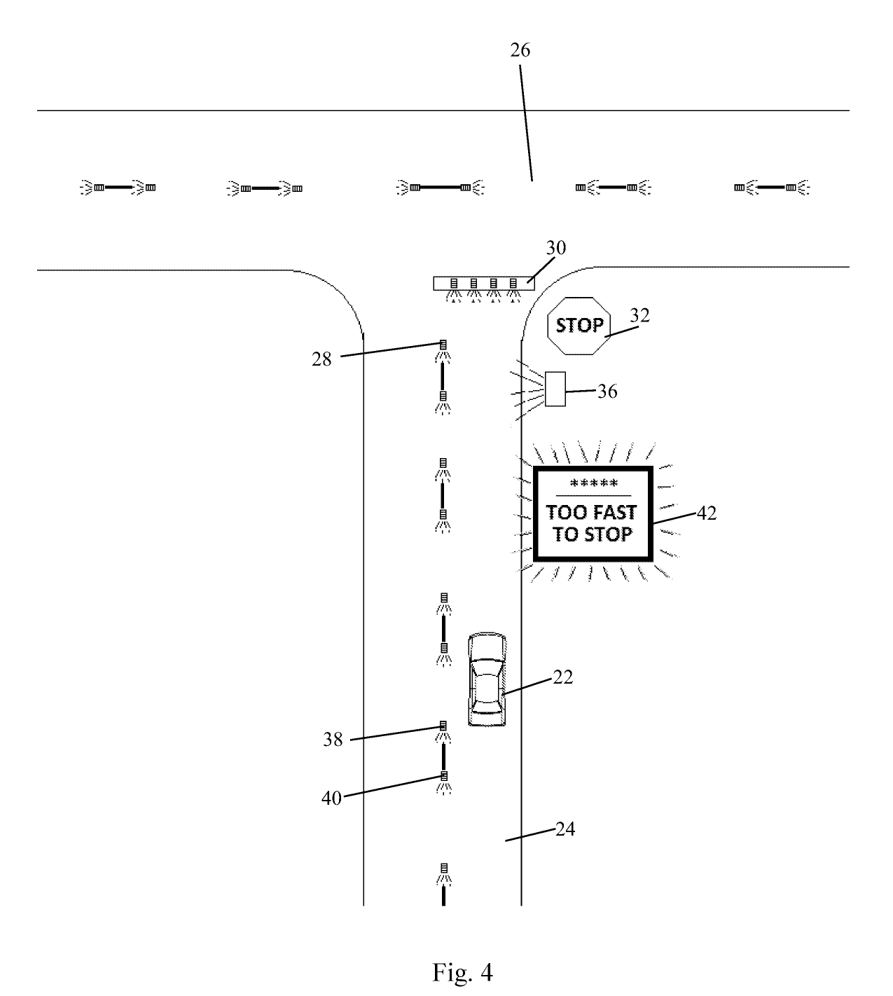

The processor utilizes the sensed speed and compares the sensed speed to the maximum speed for travel on the roadway. If the vehicle's speed exceeds the maximum speed for the roadway at the corner, the processor sends a signal to the road modules and/or one or more light strips 38, 40 leading up to the curve and optionally road modules and/or one or more light strips in the surface of the road 26 beyond the intersection. The signal directs the road modules and/or one or more light strips to illuminate and/or flash 28, 38, 40, thus warning the vehicle that its speed is too high for the approach to the intersection. Optionally a sign 42, as is already known in the art, can display notification to the vehicle that it is traveling too fast as it approaches the intersection in conjunction with the use of the roadway markers embedded in or affixed to the surface of the road. FIG. 4 depicts a view of the system of FIG. 3 but without the light strips installed. The system can be installed using road modules, light strips, or both as illustrated in FIG. 3.

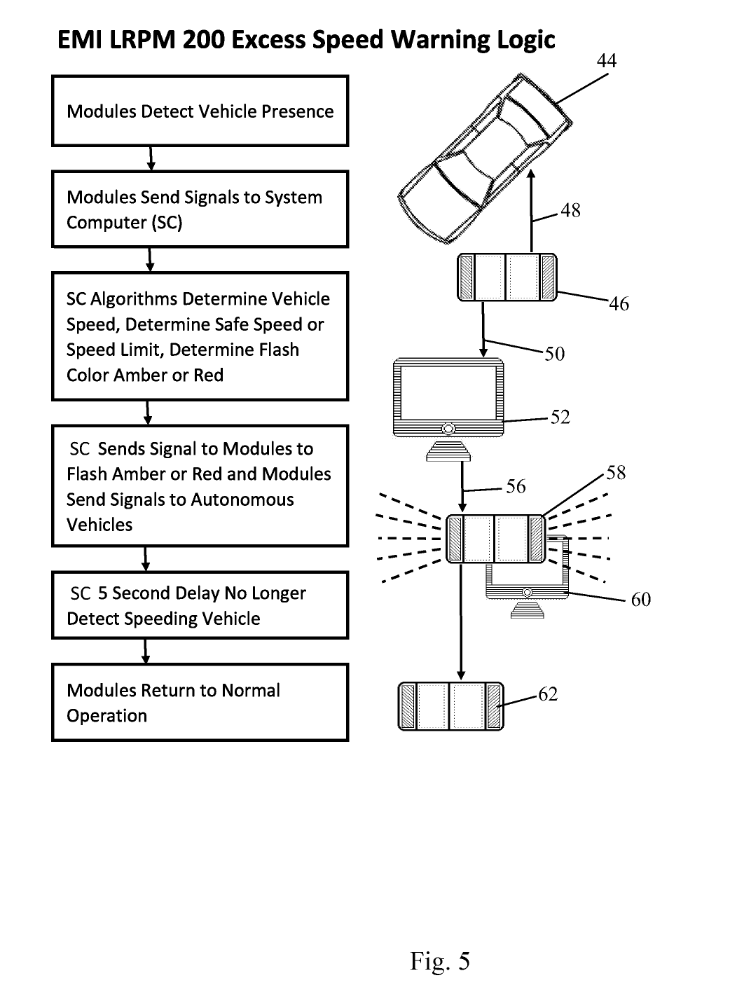

FIG. 5 depicts a logic diagram for the operation of the system. FIG. 3 depicts a vehicle 34 speed being sensed 48 by a sensor located in a road module 46. The road module sends a signal 50 to a processor 52 located either integral with the road module or exterior to the road module and capable of communicating with the road module via wireless and/or wired connection. If the vehicle is traveling too fast for the road module, the processor sends 56 a signal to one or more road modules and/or one or more light strips directing the road module to flash and/or illuminate. If sensor no longer detects a speeding vehicle, the processor directs the road module(s) 62 to stop flashing.

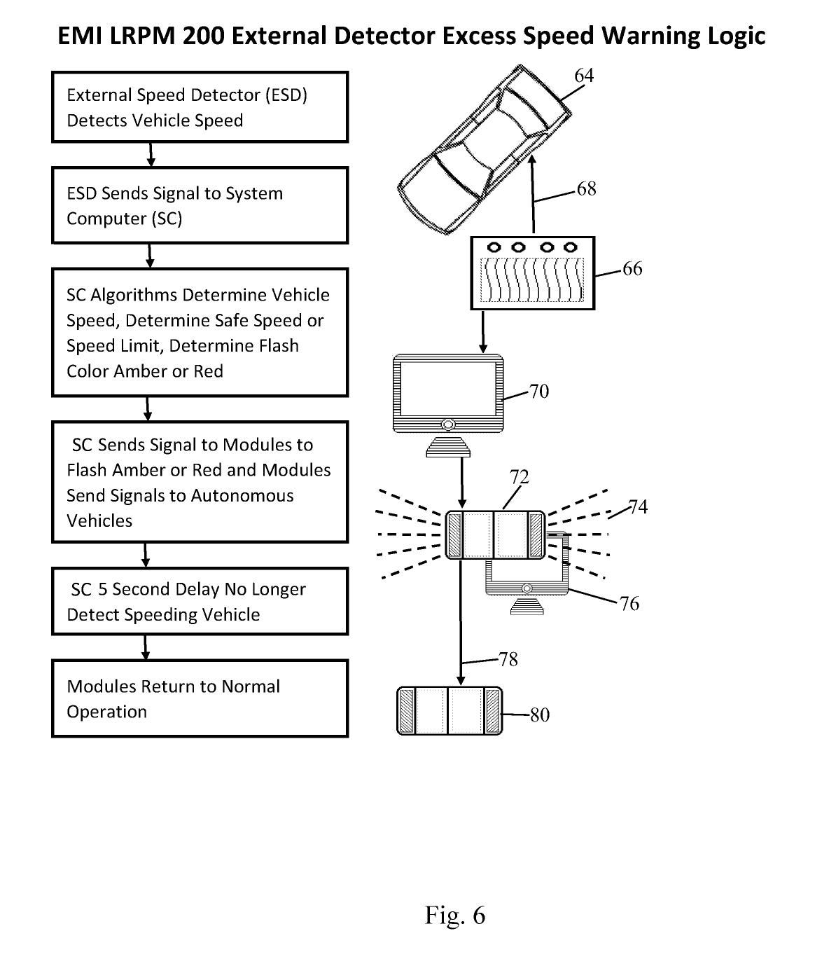

FIG. 6 depicts a logic diagram for the operation of the system. FIG. 4 depicts a vehicle 64 speed being sensed 68 by a sensor 66 located exterior to a road module 46. The sensor is located such that it is able to sense the speed of a vehicle approaching a corner or intersection. The sensor provides a signal to a processor 70 via wireless or wired communication of the speed of the vehicle. Alternatively the sensor and processor can be an integral unit. The processor directs the road modules and/or one or more light strips to illuminate and/or flash if the vehicle approaching the corner or intersection is traveling at too high of a rate of speed. When the absence of a vehicle traveling at too high of a rate of speed is no longer detected, the processor directs the road modules and/or one or more light strips 80 to de-illuminate and/or stop flashing 78 and/or to return to their normal operation.

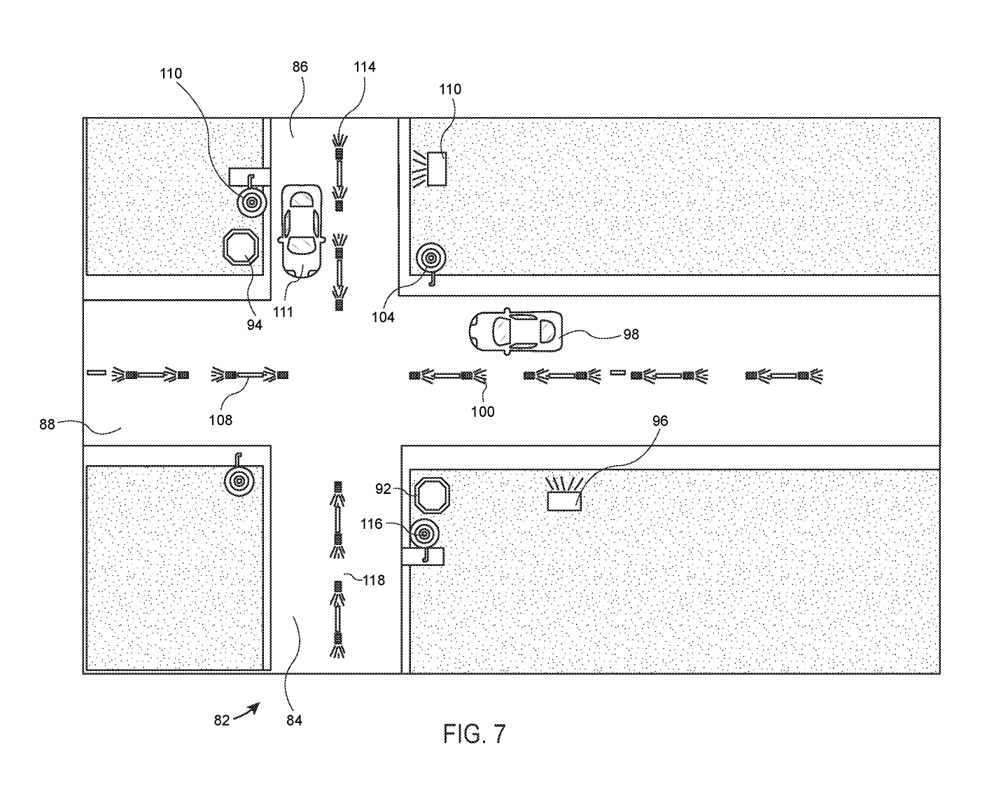

FIG. 7 illustrates an alternative embodiment of the invention in which the embodiment is utilized at an intersection between a major a road 88 and a minor road 86. The minor road intersects a major road. Stop signs 94, 92 are positioned to direct users of the minor road to stop before crossing or turning onto the major road. Sensors 96, 110 are utilized to sense vehicles traveling on the major road and the minor road. Alternatively these roadways can be called a first roadway and a second roadway. When a vehicle 111 approaches the intersection of the major road on the minor road, sensor 110 detects the vehicle approaching. The sensor triggers the sign 104 that signals vehicle 98 that the vehicle 111 is approaching the intersection of the minor road and the major road. Light road modules 100 and/or light strips positioned in or on the roadway signal to the vehicle 98 that vehicle 111 is at the intersection.

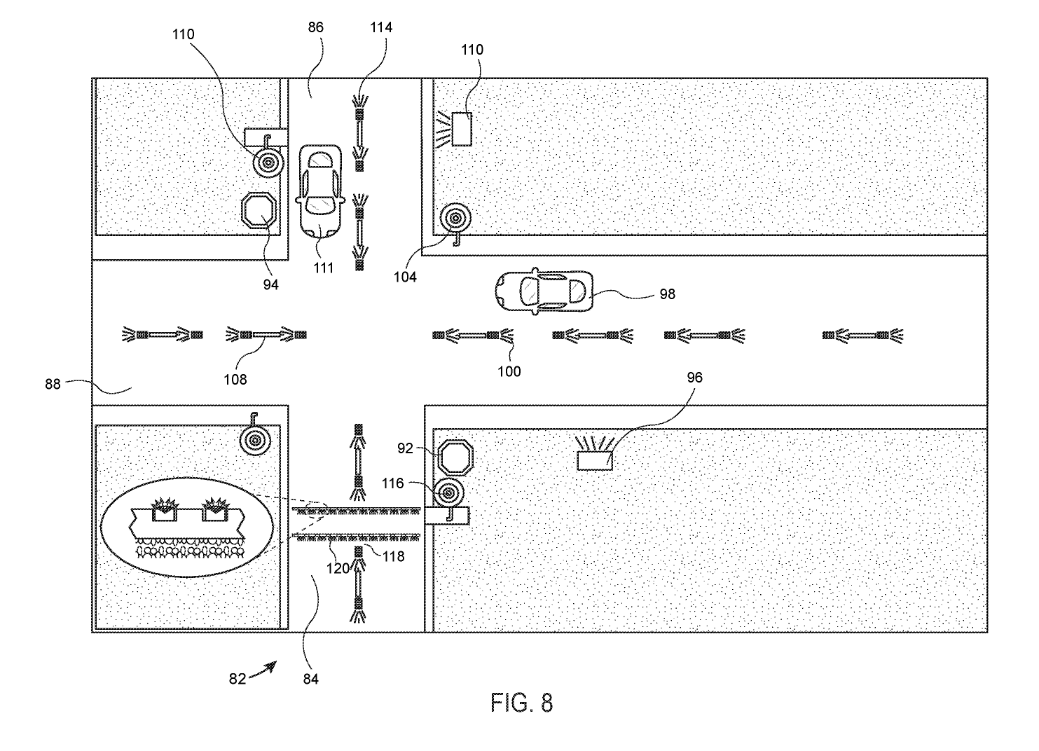

In a preferred embodiment, sensor 96 detects the approaching vehicle 98 to the intersection. The sensor causes the signage 116, 112 and lights 118, 114 to illuminate and/or display a message to the vehicle approaching on the major roadway, that there is a vehicle at the intersection of the minor road Similarly, sensors (not shown) can be utilized to detect vehicles traveling on the minor road from the upper position 84 or the major road from position 88. FIG. 8 depicts the intersection of FIG. 7 but with light strips 120 installed along with road modules.

In a preferred embodiment, the processor communicates to the road modules and/or one or more light strips using a transmitter and receiver or by an integrated transceiver. In a preferred embodiment, the processor utilizes an antennae to receive wireless communication from one or more sensors. In a preferred embodiment, one or more road modules and/or one or more light strips can utilize a receiver, transmitter, and/or transceiver to communicate wirelessly with the processor. The road modules and/or one or more light strips can be configured to only receive communication or can be configured to send and receive communication. In a preferred embodiment, the road modules and/or one or more light strips utilize one or more antennae to receive wireless communication and/or may be configured for wired communications.

What is claimed is:

1. A method of providing enhanced traffic signaling in response to road surface conditions and/or traffic conditions, said method comprising the following steps:
the step of providing a plurality of road modules and/or one or more light strips, wherein said road modules and/or one or more light strips comprise a light configured for illumination and de-illumination, wherein said road modules and/or one or more light strips are embedded in or affixed to the surface of a roadway; wherein said road modules and/or one or more light strips comprise a receiver configured for communicating with a processor, wherein said road modules and/or one or more light strips are configured to illuminate, change color, and/or flash in response to a communication from said processor;
the step of providing at least one sensor configured for detection of the speed of a vehicle traveling on the surface of said road;
the step of providing at least one processor configured for communication with said sensor and configured for communication with said plurality of road modules and/or one or more light strips, wherein said processor is configured to communicate to said road modules and/or one or more light strips to illuminate, change color, and/or flash when a vehicle is traveling on said surface of said road at a speed in excess of a predetermined maximum allowable speed; and
the step of sensing via said sensor the speed of a vehicle traveling on said road and communicating said speed to said processor;
the step of comparing by said processor said speed of said vehicle traveling on said road and comparing said speed of said vehicle traveling on said road to said maximum allowable speed;
the step of sending a signal via said processor to said road modules and/or one or more light strips to illuminate and/or flash if said vehicle is traveling in excess of said maximum allowable speed.

2. The method of providing enhanced traffic signaling of claim 1, wherein said road modules and/or one or more light strips are embedded in and/or affixed to the surface of a road proximate to a road corner and/or road intersection.

3. The method of providing enhanced traffic signaling of claim 1, wherein said road modules and/or one or more light strips are embedded in or affixed to a surface of a road proximate to a road corner, road intersection and/or other location where notification of excessive speed is warranted such as school, construction and municipality speed zones.

4. The method of providing enhanced traffic signaling of claim 1, wherein said road modules and/or one or more light strips comprise a solar module and/or a vibration energy harvesting device and an energy storage device. Alternatively, the road modules and/or light strips can be wired for power from an external source.

5. The method of providing enhanced traffic signaling of claim 1, wherein said step of providing at least one road module and/or one or more light strips comprises providing at least one road module comprising an antennae configured for receiving wireless communication from said processor.

6. The method of providing enhanced traffic signaling of claim 1, wherein said step of providing at least one processor in connection with said sensor comprises providing at least one processor configured for wireless communication with said sensor.

7. The method of providing enhanced traffic signaling of claim 1, wherein said step of providing at least one processor in connection with said sensor comprises providing at least one processor configured for wired communication with said sensor.

8. The method of providing enhanced traffic signaling of claim 1, wherein said step of providing at least one processor comprises the step of providing a processor configured to communicate with a computer located in a vehicle, wherein said processor is configured to communicate wirelessly to said computer located in said vehicle that said vehicle is traveling at a speed in excess of a predetermined maximum allowable speed.

9. The method of providing enhanced traffic signaling of claim 1, wherein said step of providing at least one processor comprises the step of providing a processor configured to communicate with a computer located onboard a vehicle comprises providing at least one processor comprises the step of providing a processor configured to communicate with a computer located onboard an autonomous vehicle.

10. The method of providing enhanced traffic signaling of claim 1, wherein said method further comprises the step of providing a road sign located proximate to said road corner and/or intersection, wherein said road sign is in communication with said processor, wherein said road sign is configured to display a message alerting said vehicle that said vehicle is traveling too fast in response to a communication from said processor.

11. The method of providing enhanced traffic signaling of claim 1, wherein said method further comprises the step of said processor communicating to said road module to de-illuminate, stop changing color, and/or stop flashing when said vehicle is no longer travelling at an excessive speed proximate to said road corner and/or road intersection.

12. The method of providing enhanced traffic signaling of claim 1, wherein said step of providing a plurality of road modules and/or one or more light strips embedded in or affixed to a road surface comprises providing a plurality of road modules and/or one or more light strips embedded in or affixed to a road surface, either within, proximate, or transverse to lines or striping delineating roadway traffic lanes or otherwise.

13. The method of providing enhanced traffic signaling of claim 1, wherein said road modules and/or light strips are embedded in or affixed to the road surface spanning a partial lane of travel, a complete lane of travel, and/or across the entire roadway.

14. The method of providing enhanced traffic signaling of claim 12, wherein a continuous light strip and/or at least two light strips are positioned adjacent to one another in a lane to provide the appearance of a continuous light strip.

15. A method of providing enhanced traffic signaling in response to road surface conditions and/or traffic conditions, said method comprising the following steps:
the step of providing a plurality of road modules and/or one or more light strips, wherein said road modules and/or one or more light strips are embedded in or affixed to the surface of a roadway; wherein said road modules and/or one or more light strips comprise a light configured for illumination and de-illumination, wherein said road modules and/or one or more light strips comprise a receiver configured for communicating with a processor, wherein said road modules and/or one or more light strips are configured to illuminate, change color, and/or flash in response to a communication from said processor;
the step of providing at least one sensor configured for detection of a vehicle approaching an intersection of two or more roadways;
the step of providing at least one processor configured for communication with said sensor and configured for communication with said plurality of road modules and/or one or more light strips, wherein said processor is configured to communicate to said road modules and/or one or more light strips to illuminate, change color, and/or flash when a vehicle is traveling on a first roadway toward said intersection of two or more roadways, wherein said first roadway intersects with a second roadway at said intersection, wherein said road modules and/or light strips are embedded in or on said second roadway;
the step of sensing via said sensor an event of a vehicle traveling on said first roadway toward said intersection and communicating said event to said processor; and
the step of said processor sending a signal to said road modules and/or one or more light strips in or on said second roadway to illuminate and/or flash.

16. The method of claim 15, wherein said road intersection comprises stop signs directing roadway travelers on said second roadway to stop at said intersection.

17. The method of claim 15, wherein said road intersection comprises stop signs directing roadway travelers on said first roadway to stop at said intersection.

18. The method of claim 15, wherein said road intersection comprises a sign configured to display a verbal warning to roadway travelers in said first roadway when a vehicle is traveling on said second roadway and approaching said intersection, wherein said processor is configured to communicate to said sign to display said verbal warning when said sensor detects a vehicle traveling on said second roadway and approaching said intersection.

19. The method of claim 15, wherein said road intersection comprises at least one traffic signal light.
